(19) United States
(12) Patent Application Publication
(10) Pub. No.: US 2012/0287928 A1
(43) Pub. Date: Nov. 15, 2012

(54) COMMUNICATION APPARATUS AND METHOD OF CONTROLLING SAME, AND STORAGE MEDIUM

(75) Inventor: Go Inoue, Fujisawa-shi (JP)

(73) Assignee: CANON KABUSHIKI KAISHA, Tokyo (JP)

(21) Appl. No.: 13/461,976

(22) Filed: May 2, 2012

(30) Foreign Application Priority Data
May 9, 2011 (JP) 2011-104741

(51) Int. Cl. H04L 12/56

(52) U.S. Cl. 370/390

(57) ABSTRACT

In a communication apparatus for communicating with a network device and a method of controlling this apparatus, a filter condition that includes an address of the communication apparatus is enabled if a setting has been made so as to capture a packet addressed to the communication apparatus. On the other hand, if a setting has been made so as to capture a packet relating to the communication apparatus, then a filter condition that includes a broadcast address and/or a multicast address in addition to the address of the communication apparatus is enabled. If a received packet satisfies the filter condition, then this packet is captured.

### BACKGROUND OF THE INVENTION

1. Field of the Invention

The present invention relates to a communication apparatus for subjecting received data to filter processing, a method of controlling this apparatus and a storage medium storing a program for implementing this method.

2. Description of the Related Art

The growing complexity of network environments, increase in traffic and appearance of new protocols in recent years have been accompanied by an increase in network-related failures. Examples of such failures that can be mentioned include an inability to connect to the network, slow speed and the occurrence of cutoff from the network.

When such a network failure occurs, the general practice is to use a personal computer to execute an application tool for acquiring a network packet and to ascertain the cause of the failure by monitoring the network packet. However, in order for the personal computer to acquire a network packet being sent to and received by a certain device, it is necessary to change the network configuration or to change switch settings. This involves labor and tends to result in operating error. In addition, if the network configuration has been changed, there are instances where the failure phenomenon changes and it cannot be assured that the packet that is the cause of the failure will always be acquired.

Japanese Patent Laid-Open No. 2009-152762 proposes a method of solving this problem by installing a packet acquisition application not in a personal computer but in an embedded device such as a multifunction peripheral or the like and using this application to acquire the network packet. By virtue of this method, it is possible for information to the effect that the embedded device is sending and receiving an improper packet to be judged within the embedded device without use of a personal computer or the like.

Unlike a personal computer, however, an ordinary embedded device is limited in terms of a storage area for storable packet data. This means that in a case where packet acquisition is activated in a non-filtering mode, all network packets received by the embedded device are acquired and stored. The problem which arises is that the storage area soon becomes filled to capacity.

Further, in a case where a packet has been acquired in a mode that is for acquiring only packets that contain the MAC address of the local device, a multicast packet or the like will not be in conformity with the filter condition and will be discarded. In other words, when this filter mode is used, a problem which arises is that a multicast packet actually received and processed can no longer be acquired. In other words, a problem which arises is that, if acquired packet size increases in the non-filtering mode and the filtering mode is then set, then packets related to the local device cannot be acquired.

### SUMMARY OF THE INVENTION

An aspect of the present invention is to eliminate the above-mentioned problems of the conventional technology.

The present invention provides a technique in which a related multicast address is obtained and reflected in filter conditions, thereby making it possible to acquire a packet related to the local device even in a filter mode.

According to an aspect of the present invention, there is provided a communication apparatus capable of communicating with a device on a network for capturing packets transmitted from the device, the apparatus comprising: a setting unit configured to perform a setting for capturing a packet addressed to the communication apparatus or a setting for capturing a packet relating to the communication apparatus; a control unit configured to enable a filter condition, which includes an address of the communication apparatus, in a case where the setting unit has performed the setting for capturing a packet addressed to the communication apparatus, and to enable a filter condition, which includes a broadcast address and/or a multicast address in addition to the address of the communication apparatus, in a case where the setting unit has performed the setting for capturing a packet relating to the communication apparatus; a determination unit configured to determine whether a packet received via the network satisfies the filter condition; and a capture unit configured to capture the received packet in a case where the determination unit has determined that the filter condition is satisfied.

Further features and aspects of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram illustrating the configuration of a network system employing an image forming apparatus, which is an embedded device, according to an embodiment of the present invention;

FIG. 2 is a block diagram useful in describing the hardware configuration of an MFP (MultiFunction Peripheral) according to this embodiment;

FIG. 3 is a block diagram useful in describing the software configuration of an MFP;

FIG. 4 is a diagram illustrating an example of a capturing filter table according to the embodiment;

FIG. 5 is a diagram illustrating an example of an IP filter table;

FIG. 6 is a diagram illustrating an example of a WOL table;

FIG. 7 is a flowchart for describing processing executed by a packet capture control section according to a first embodiment of the present invention;

FIG. 8 is a diagram illustrating an example of a table indicating correspondence between protocols and multicast addresses;

FIG. 9 is a flowchart for describing processing executed by a packet capturing process section according to the first embodiment;

FIG. 10 is a diagram for describing an example of a sequence in the filter mode of an MFP according to the first embodiment;

FIG. 11 is a flowchart for describing packet capturing processing according to a second embodiment of the present invention; and

FIGS. 12A and 12B are diagrams for describing an example of a processing sequence in the filter mode of an MFP according to the second embodiment.

### DESCRIPTION OF THE EMBODIMENTS

Embodiments of the present invention are described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

It should be noted that in this embodiment, a case will be described in which an embedded device calculates a multicast packet acquired from a set value and reflects the packet dynamically.

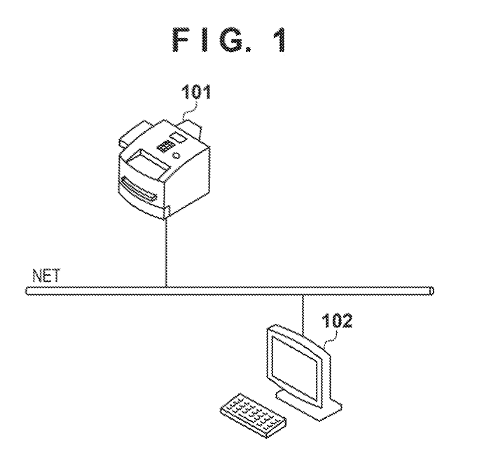

FIG. 1 is a diagram illustrating the configuration of a network system employing an image forming apparatus 101, which is an embedded device, according to this embodiment of the present invention.

The image forming apparatus 101 and a host computer 102 are connected via a network (NET) and are capable of executing processing for sending and receiving data to and from each other. It should be noted that image forming apparatus 101 is an MFP (MultiFunction Peripheral) having functions such as a copy function, facsimile function, print function and storage function.

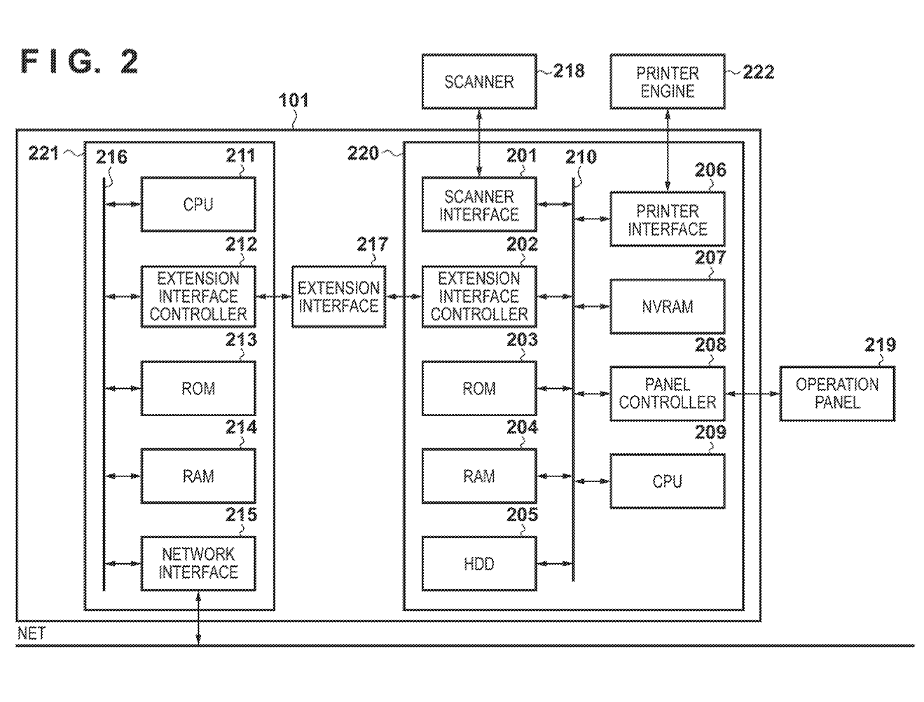

FIG. 2 is a block diagram useful in describing the hardware configuration of the MFP 101 according to this embodiment.

The MFP 101 includes two units, namely a unit 220 having a CPU 209, and a unit 221 having a CPU 211. It should be noted that the unit 220 will be referred to as the controller of the MFP 101 and that the unit 221 will be referred to as the NIC (Network Interface Card) of the MFP 101. The MFP 101 has a power conserving function and achieves a reduction in power consumption by supplying electric power only to the unit (NIC) 221 and halting the supply of power to other units when the MFP is in the sleep state.

The controller 220 will be described first. A program ROM in a ROM 203 stores a control program, etc., executable by the CPU 209, and a data ROM in the ROM 203 stores information and the like utilized by the controller 220. In accordance with the control program stored in the program ROM of ROM 203, the CPU 209 exercises overall control of access to various devices connected to a system bus 210. The CPU 209 outputs an image signal as output information to a printer engine 222 connected to a printer interface 206 and receives and processes an image signal that enters from a scanner 218 connected via a scanner interface 201. A RAM 204 primarily functions as a main memory and work area of the CPU 209 and is arranged so that the memory capacity thereof can be extended by an optional RAM connected to an expansion port, not shown. A hard-disk drive (HDD) 205 stores font data, an emulation program and form data and the like, spools a print job temporarily and is used as a job storage area for controlling a spooled job externally. The hard-disk drive 205 further retains, as box data, image data that has entered from the scanner 218 or the image data of a print job, the drive is referred to from the network and it is used as a data storage area for the purpose of printing. A non-volatile memory (NVRAM) 207 accepts and stores various settings information, via a panel controller 208, set using an operation panel 219.

The NIC 221 will be described next. A program ROM in a ROM 213 stores a control program, etc., executable by the CPU 211, and a data ROM in the ROM 213 stores information and the like utilized by the NIC 221. In accordance with the control program stored in the program ROM of ROM 213, the CPU 211 exercises overall control of access to various devices connected to a system bus 216. A RAM 214 primarily functions as a main memory and work area of the CPU 211. The CPU 211 is capable of executing processing for communicating with a host computer and image forming apparatus on the network via a network interface 215.

The controller 220 and NIC 221 are connected via an extension interface 217. The CPU 209 of the controller 220 is capable of sending and receiving data to and from the NIC 221 via the extension interface 217 and an extension interface controller 202. Similarly, the CPU 211 of the NIC 221 is capable of sending and receiving data to and from the controller 220 via the extension interface 217 and an extension interface controller 212.

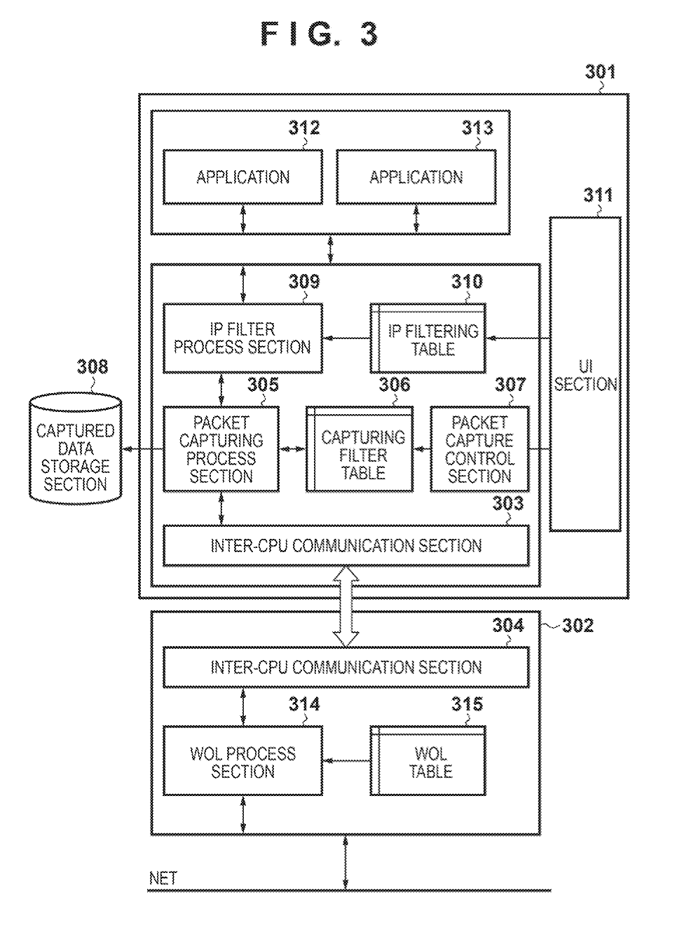

FIG. 3 is a block diagram for describing the software configuration of the MFP 101. Process and control sections of a main CPU firmware 301 shown in FIG. 3 are implemented by having the CPU 209 execute the program stored in the program ROM.

The software of the MFP 101 is divided broadly into main CPU firmware 301 that operates in a non-sleep state and subordinate CPU firmware 302 that operates in a sleep state. The main CPU firmware 301 will be described first.

If a network packet has been received from the outside, the received packet data is processed by a packet capturing process section 305. In case of operation in the non-filtering mode, the packet capturing process section 305 stores all received packet data in a captured data storage section 308. In case of operation in the filtering mode, on the other hand, the packet capturing process section 305 refers to a capturing filter table 306 and stores in a storage area of the captured data storage section 308 only packet data that satisfies a filter condition. Received packet data is transferred to an IP filter process section 309 as is in both modes (non-filtering mode and filtering mode) of operation. In response to an instruction entered by a user via a UI (User Interface) section 311, a packet capture control section 307 executes processing for updating the capturing filter table 306.

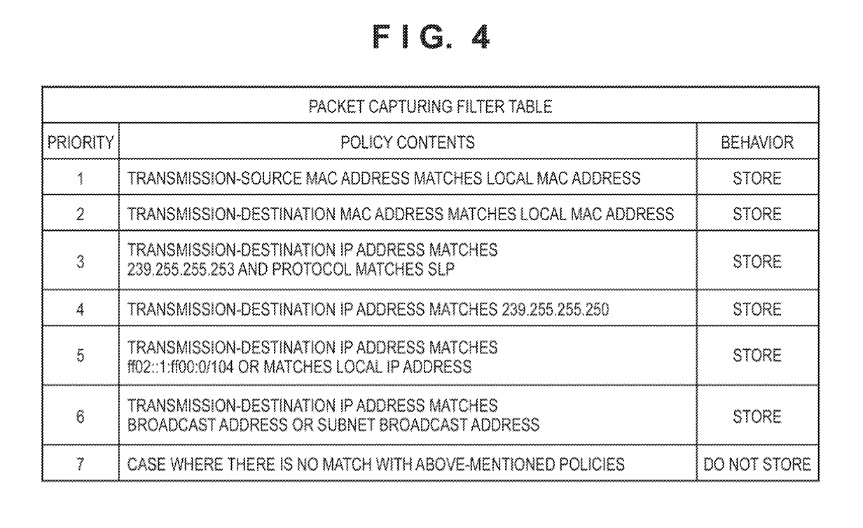

FIG. 4 is a diagram illustrating an example of the capturing filter table 306 according to an embodiment.

Conditions are checked starting from a policy of priority “1” and the moment a condition is satisfied, an operation (“STORE” or “DO NOT STORE” in FIG. 4) indicated under “BEHAVIOR” is performed.

The IP filter process section 309 refers to an IP filtering table 310 and determines whether all received packet data is in conformity with a filter condition. If there is conformity with a “DISCARD” filter condition, the packet data is promptly discarded and this received data is not transferred as far as the application layer. If there is conformity with a “PERMIT” filter condition, then the received packet data is transferred to a higher-order application layer as is.

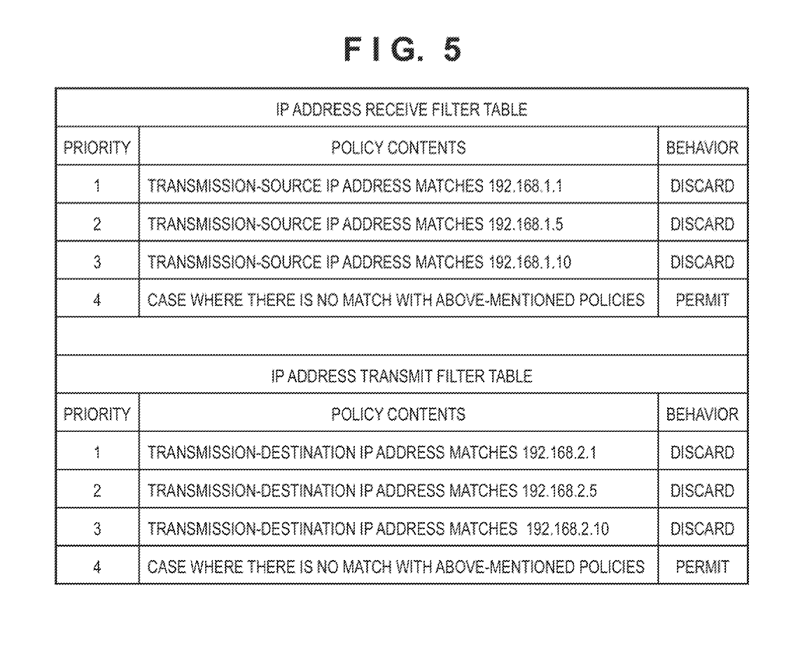

FIG. 5 is a diagram illustrating an example of the IP filtering table 310.

Conditions are checked starting from a policy of priority “1” and the moment a condition is satisfied, an operation (“DISCARD” or “PERMIT” in FIG. 5) indicated under “BEHAVIOR” is performed.

Applications 312 and 313, which are applications run by the MFP 101, transmit a packet in reply to a received packet and transmit their own packets. It should be noted that, in a case also where an application transmits a packet autonomously, the sequence is opposite that at the time of reception, with filtering processing being executed first by the IP filter process section 309 followed by execution of capture processing by the packet capturing process section 305.

By using the UI section 311, the user can apply various settings to the MFP 101 via the operation panel 219. For example, a WSD (Web Services on Devices) setting in the MFP 101 can be enabled or disabled, and an SLP (Service Location Protocol) setting can be enabled or disabled.

The subordinate CPU firmware 302 will be described next.

The subordinate CPU firmware 302 is activated only in a case where the main CPU firmware 301 is in the sleep state. The subordinate CPU firmware 302 classifies received network data into two types. These two types are “DISCARD” and “TRANSFER TO MAIN CPU FIRMWARE”. “TRANSFER TO MAIN CPU FIRMWARE” indicates a case where processing of some kind is required with regard to received network data, though the network data that has been received cannot be processed solely by the NIC 221 to which power is being supplied. A WOL (Wake On LAN) process section 314 refers to a WOL table 315 and determines whether a received packet data has a pattern that will wake up the main CPU firmware 301. In case of wake-up, the WOL process section 314 executes a restoring process, shifts the MFP 101 from the sleep state to the non-sleep state and transfers the received packet data to the main CPU firmware 301. In a case where wake-up is not carried out, the WOL process section 314 discards the received packet data without application of any processing to the received packet data and does not transfer the packet data to the main CPU firmware 301.

Inter-CPU communication sections 303 and 304 are provided in the main CPU firmware 301 and subordinate CPU firmware 302, respectively, and control communication between the main CPU firmware 301 and subordinate CPU firmware 302.

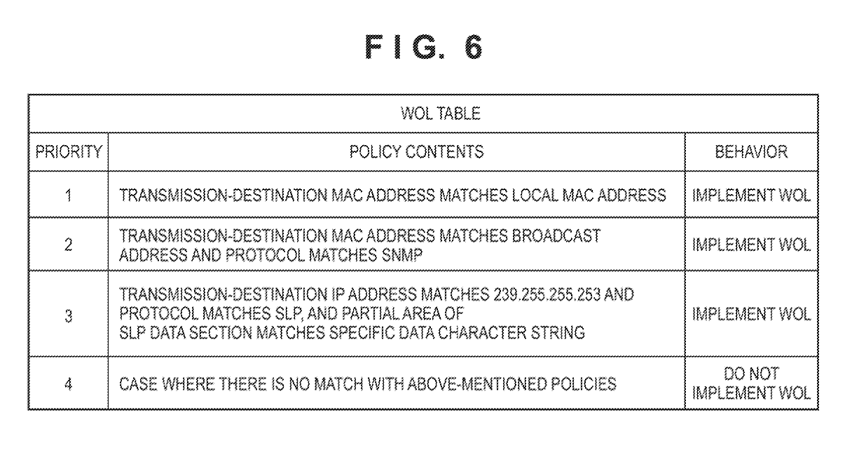

FIG. 6 is a diagram illustrating an example of the WOL table 315.

Conditions are checked starting from a policy of priority “1” and the moment a condition is satisfied, an operation (“IMPLEMENT WOL” or “DO NOT IMPLEMENT WOL” in FIG. 6) indicated under “BEHAVIOR” is performed.

### First Embodiment

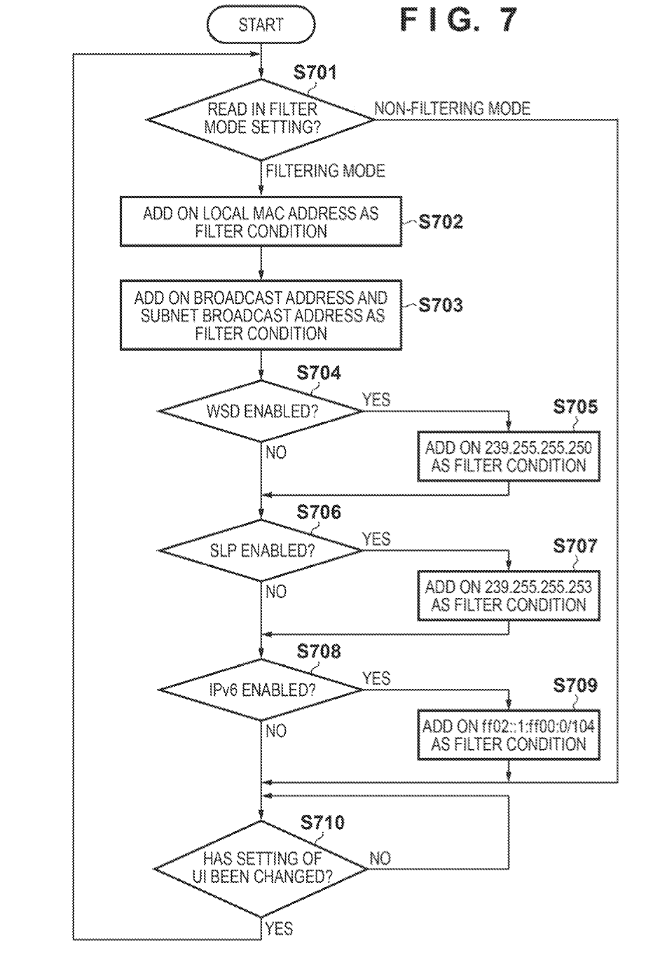

FIG. 7 is a flowchart for describing processing executed by the packet capture control section 307 according to a first embodiment of the present invention. This processing is executed by having the CPU 209 run the program that has been stored in the program ROM.

When power is introduced to the MFP 101, in step S701 the packet capture control section 307 reads in the filter mode that has been set. Filter setting modes are classified broadly into a non-filtering mode for storing all received packets and a filtering mode for storing only packets that are in conformity with filter conditions; the user can select any setting value as the filter condition. For example, it may be arranged so that, in the filtering mode, a detailed setting can be made as to under what filter condition an operation will be performed. For instance, it can be set so that an operation is performed under the condition “only packets that contain the local MAC address” or the condition “only packets relating to the local device”. In the first embodiment, a case will be described in which it is possible to set a mode for acquiring and storing only packets relating to the local device.

In case of the non-filtering mode, processing proceeds to step S710, where the packet capture control section 307 does not execute any particular processing and waits until the user changes the setting value. In case of the filtering mode, on the other hand, processing proceeds to step S702 and the packet capture control section 307 refers to the setting values and generates the capturing filter table 306.

The packet capture control section 307 captures only a packet relating to the local device, namely a packet containing the local MAC address. Accordingly, the packet capture control section 307 acquires the MAC address of the local device in step S702. The packet capture control section 307 then adds on a condition to the capturing filter table 306, the condition being “FIELD OF PACKET TRANSMISSION-SOURCE MAC ADDRESS OR OF PACKET TRANSMISSION-DESTINATION MAC ADDRESS MATCHES LOCAL MAC ADDRESS”. Next, since it is highly likely that a packet containing a broadcast address or a subnet broadcast address also is a packet relating to the local device, the packet capture control section 307 adds on these addresses also as targets of filtering in step S703. Here a subnet broadcast address is calculated from the IP address and subnet mask of the local device.

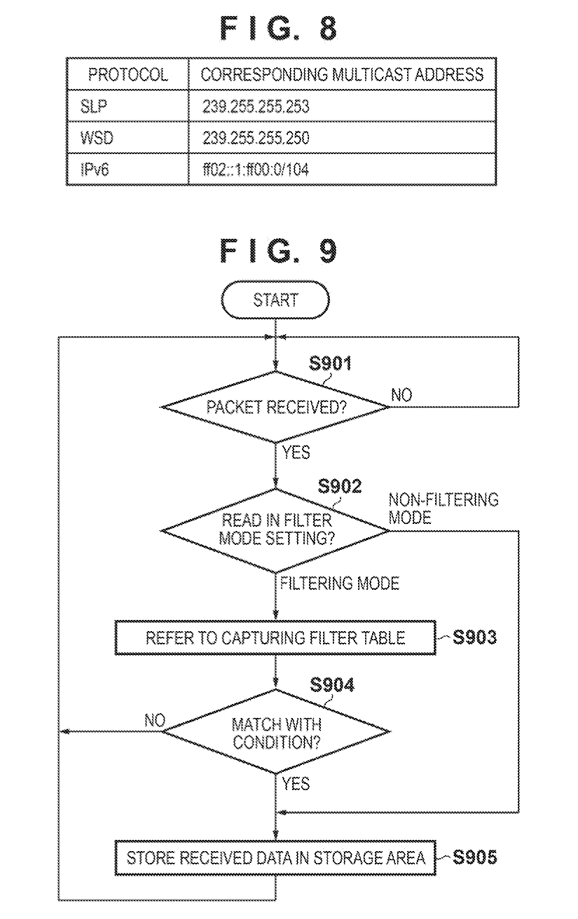

Next, the packet capture control section 307 refers to the setting values of each of the protocols and determines whether to add a condition to the capturing filter table 306. First, in step S704, the packet capture control section 307 refers to the WSD setting and, if WSD has been enabled, proceeds to step S705, but if WSD has not been enabled, proceeds to step S706. In step S705, the packet capture control section 307 adds on the condition “FIELD OF TRANSMISSION-DESTINATION IP ADDRESS MATCHES 239.255.255.250”, and then proceeds to step S706. At this time the multicast address corresponding to each protocol is decided based upon the correspondence table shown in FIG. 8, which is retained internally of the device.

FIG. 8 is a diagram illustrating an example of a table indicating correspondence between protocols and multicast addresses.

It may be arranged so that the user can change the contents of the table through a user interface or the like.

In step S706 in FIG. 7, the packet capture control section 307 refers to the SLP setting and, if SLP has been enabled, proceeds to step S707, but if SLP has not been enabled, proceeds to step S708. In step S707, the packet capture control section 307 adds on the condition “FIELD OF TRANSMISSION-DESTINATION IP ADDRESS MATCHES 239.255.255.253” and then proceeds to step S708. Next, in step S708, the packet capture control section 307 refers to the IPv6 setting and, if IPv6 has been enabled, proceeds to step S709, but if IPv6 has not been enabled, proceeds to step S710. In step S709, the packet capture control section 307 adds on the condition “FIELD OF TRANSMISSION-DESTINATION IP ADDRESS MATCHES ff02::1:ff00:0/104” and then proceeds to step S710. It should be noted that although only the IPv6 multicast address with respect to each protocol setting is shown in FIGS. 7 and 8, the corresponding IPv4 multicast address may also be added on in a similar manner.

Thus, at the moment the reference to each protocol ends, the capturing filter table 306 of the kind shown, for example, in FIG. 4 is generated. The packet capture control section 307 thenceforth waits in step S710 until the user changes the setting value. When a change to the setting value is instructed from the UI section 311, processing returns to step S701 and the packet capture control section 307 executes the processing described above.

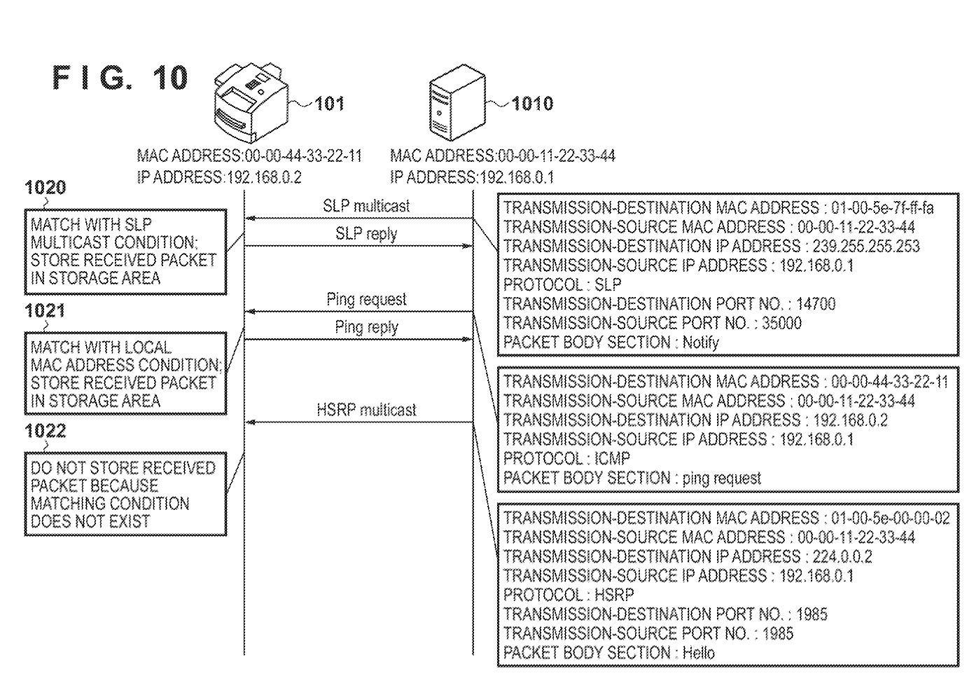

FIG. 9 is a flowchart for describing processing executed by the packet capturing process section 305 according to the first embodiment. This processing is executed by having the CPU 209 run the program that has been stored in the program ROM.

First, upon receiving a packet in step S901, the packet capturing process section 305 proceeds to step S902 and reads in the setting value of the filter mode. If the setting of the filter mode is the non-filtering mode, processing proceeds to step S905 and the packet capturing process section 305 stores the received data in a capture-data storage area (the hard-disk drive 205, for example).

On the other hand, if the setting of the filter mode is the filtering mode, the processing proceeds to step S903 and the packet capturing process section 305 refers to the capturing filter table 306. Here the packet capturing process section 305 refers to the policy contents in order of increasing priority number (i.e., in regular order starting from priority “1”) and determines in step S904 whether there is a match with a condition. If there is a match with a condition, processing proceeds to step S905 and the packet capturing process section 305 stores the received packet in the storage area (the hard-disk drive 205, for example) and then proceeds to step S901. If there is no match with the condition in step S904, processing proceeds to step S901

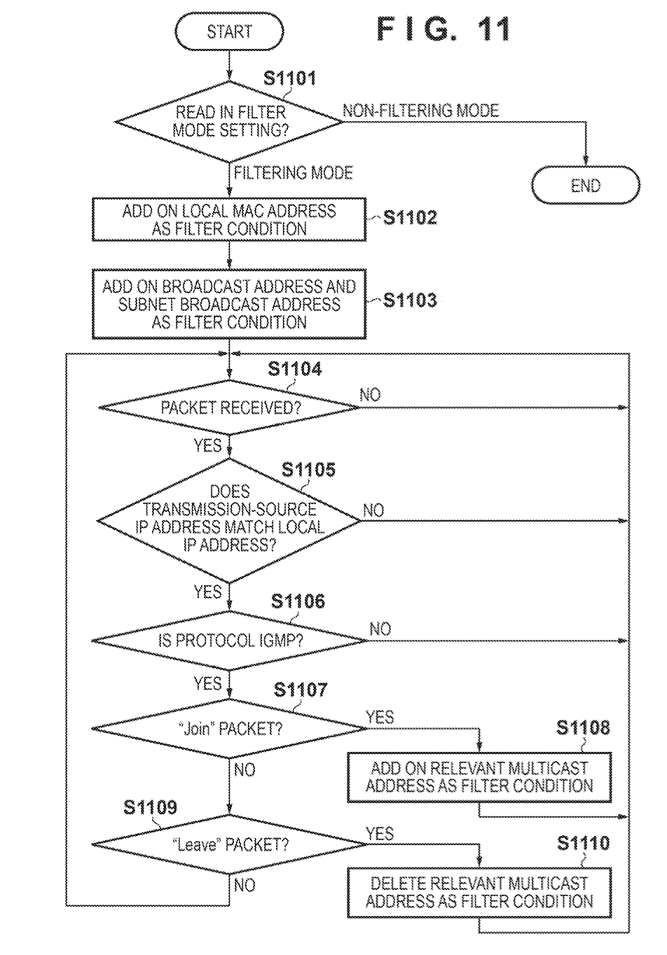

FIG. 10 is a diagram for describing an example of a sequence in the filter mode of the MFP 101 according to the first embodiment of the present invention.

Assume that the IP address of the MFP 101 equipped with the packet capture function is “192.168.0.2” and that the IP address of an external host 1010 is “192.168.0.1”. If, for example, the MFP 101 receives an SLP multicast packet from the external host 1010, the MFP 101 refers to the capturing filter table 306. Owing to the fact that the transmission-destination IP address of the packet is “239.255.255.253” and the fact that the protocol is SLP, there is match with the condition of the policy the priority of which is “3” in FIG. 4. As a result, the MFP 101 stores the received packet in the storage area (1020).

If the MFP 101 receives a ping request packet from the external host 1010, the transmission-destination MAC address of the packet matches “00-00-44-33-22-11”, which is the local MAC address. As a result, the MFP 101 stores the received packet (1021).

If the MFP 101 receives an HSRP (Hot Standby Routing Protocol) multicast packet from the external host 1010, there is no condition that matches any of the policies in capturing filter table 306 in FIG. 4. As a result, the MFP 101 eventually does not store the received packet (1022).

Conventionally, in the case of the non-filtering mode, all received packets are stored. Consequently, irrelevant packets such as HSRP packets are also stored and the storage area is used up needlessly. By contrast, with the first embodiment, irrelevant packets such as HSRP packets are not stored. Further, in the case of the filtering mode, only packets relating to the MFP 101 are stored. This is advantageous in that the storage area can be exploited efficiently and in that it is easier to perform analysis, etc., of captured data after storage.

### Second Embodiment

In the first embodiment described above, management is performed using, for example, the table of FIG. 8 indicating correspondence between protocols and multicast addresses. But assume, for example, that in a case where an additional application has been installed in the MFP 101, the application uses a multicast address that does not exist in this table. In such case this multicast packet will not match a filter condition and, hence, the received packet cannot be acquired. Accordingly, in the second embodiment, a technique is described in which even if a new multicast packet appears, it can be acquired without omission without referring to a table of the kind shown in FIG. 8. It should be noted that the system configuration and MFP configuration in the second embodiment are similar to those of the first embodiment and need not be described again.

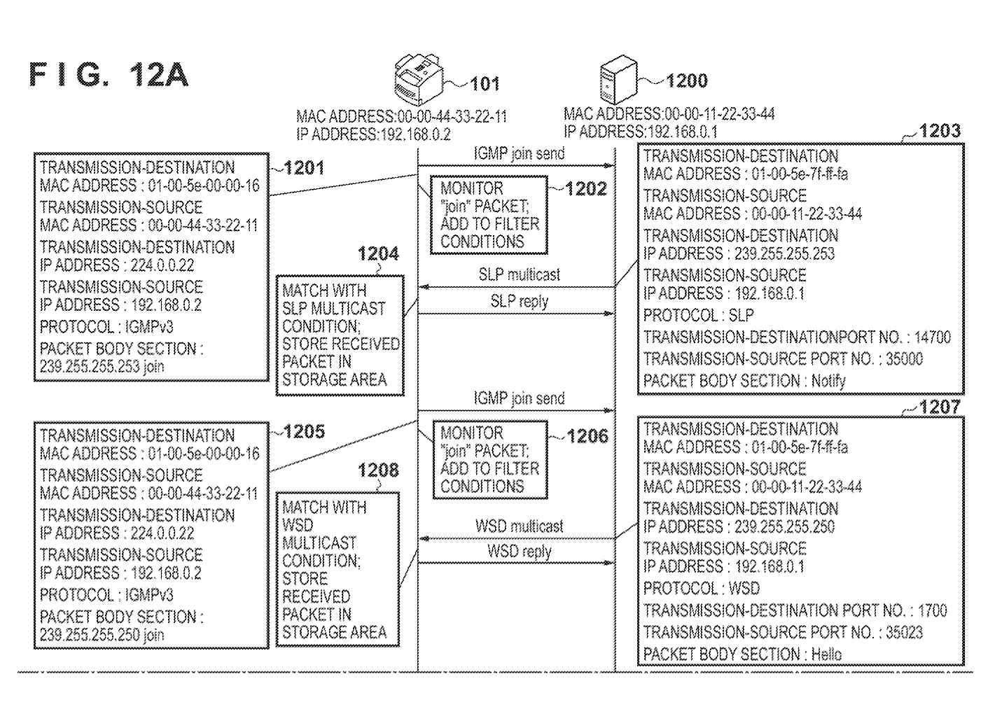

FIG. 11 is a flowchart for describing packet capturing processing according to the second embodiment of the present invention. This processing is executed by having the CPU 209 run the program that has been stored in the program ROM.

The process for reading in the filter mode setting and the process for adding a local MAC address and broadcast address to the capturing filter table if the filtering mode is in effect (steps S1101 to S1103 in FIG. 11) are the same as in the first embodiment (steps S701 to S703 in FIG. 7), so the explanation of the steps of S1101 to S1103 is omitted.

In step S1104, processing for monitoring receipt of a packet is started. If the packet capturing process section 305 receives a packet, processing proceeds to step S1105. Here whether the value of the transmission-source IP address of the received packet matches the local IP address is discriminated. In other words, whether the packet has been transmitted by the local device is discriminated. If there is a match, then this means that the packet is one that was transmitted by the local device. When there is no match, processing returns to step S1104. If there is a match, however, then processing proceeds to step S1106, reference is had to the protocol field of the received packet and whether this packet is in compliance with the IGMP (Internet Group Management Protocol) is discriminated. Specifically, whether the protocol field of this packet is the value “0x02”, which is indicative of IGMP, is discriminated. IGMP is a protocol indicative of control whereby a host can be registered with a router in order to receive a specific multicast packet. By monitoring this protocol packet, whether the MFP 101 has joined or left a multicast group can be discriminated.

If it is discriminated in step S1106 that this packet is an IGMP packet, processing proceeds to step S1107. Here the type of this IGMP packet is identified to determine whether there is match with “join” or “leave”. Broadly speaking, there are three versions of IGMP, and the field to which reference is made differs depending upon the version. For instance, in case of version IGMPv3, “join” is discriminated if the Record Type field is “0x04” (Change to Exclude Mode). Further, “leave” is discriminated if the field is “0x03” (Change to Include Mode).

In case of version IGMPv2, “join” is discriminated if the Message Type field is “0x11” (Membership Query). Further, “leave” is discriminated if the field is “0x17” (Leave Report). For the details of IGMP, refer to RFC.

If a “join” packet is identified in step S1107, processing proceeds to step S1108. Here the multicast address that is to join is added to the capturing filter table 306. Further, if a “leave” packet is identified in step S1109, processing proceeds to step S1110. Here the multicast address that is to leave is deleted from the capturing filter table 306.

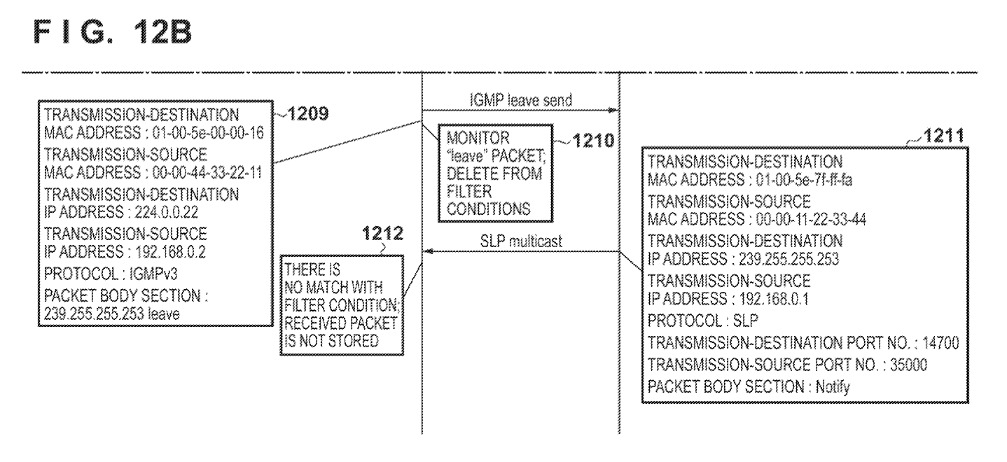

FIGS. 12A and 12B are diagrams for describing an example of a processing sequence in the filter mode of the MFP 101 according to the second embodiment. Assume that the IP address of the MFP 101 equipped with the packet capture function is “192.168.0.2” and that the IP address of an external host 1200 is “192.168.0.1”.

Assume that the packet capture control section 307 is constantly monitoring packets sent and received by the MFP 101. If the MFP 101 has transmitted a “join” packet 1201 to IP address “239.255.255.253”, the packet capture control section 307 can sense this packet. The packet capture control section 307 adds the transmission-destination IP address “239.255.255.253” to the capturing filter table 306 as a filter condition (1202). Thereafter, when an SLP multicast packet 1203 whose transmission-destination IP address is “239.255.255.253” is received, there is a match with a condition in the capturing filter table 306. The packet capture control section 307 therefore stores the received packet in the storage area (hard-disk drive 205) (1204).

Similarly, if the MFP 101 has transmitted a “join” packet 1205 to IP address “239.255.255.250”, the packet capture control section 307 can sense this packet. The packet capture control section 307 adds the transmission-destination IP address “239.255.255.250” to the capturing filter table 306 as a filter condition (1206). Thereafter, when a WSD multicast packet 1207 whose transmission-destination IP address is “239.255.255.250” is received, there is a match with a condition in the capturing filter table 306. Therefore the received packet is stored in the storage area (hard-disk drive 205) (1208).

Further, if the MFP 101 has transmitted a “leave” packet 1209 to IP address “239.255.255.253”, the packet capturing process section 305 can sense this packet. The packet capturing process section 305 deletes this IP address “239.255.255.253” as a filter condition from the capturing filter table 306 (1210 in FIG. 12B). If an SLP multicast packet 1211 whose transmission-destination IP address is “239.255.255.253” is subsequently received, there is no match with a condition in the capturing filter table 306 and, hence, this received packet is not stored (1212).

Thus, by constantly monitoring IGMP packets transmitted by the MFP 101 and adding on or deleting addresses as filter conditions in accordance with “join” and “leave”, optimum filter conditions can be retained dynamically. As a result, not only is it possible to efficiently store only packets relating to the local device but, even if an application or the like newly installed in the MFP 101 handles a new multicast packet, it is also possible to deal with such a packet without omission.

In this embodiment, whether a multicast group is joined or left is sensed by monitoring the IGMP packet. However, similar processing can be executed by monitoring a packet other than an IGMP packet so long as the packet is one that enables the joining or leaving of a multicast group to be sensed. That is, a specific packet for the purpose of sensing the joining or leaving of a multicast group is limited to the IGMP packet.

### Other Embodiments

In the embodiments set forth above, an MFP is described as an example of a communication apparatus. However, the present invention is not limited to an MFP and is applicable to all types of communication apparatus capable of sending and receiving data over a network.

Further, it is possible to work the present invention by suitably combining the first and second embodiments described above.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-104741, filed May 9, 2011, which is hereby incorporated by reference herein in its entirety.

What is claimed is:

1. A communication apparatus capable of communicating with a device on a network for capturing packets transmitted from the device, the apparatus comprising:
a setting unit configured to perform a setting for capturing a packet addressed to the communication apparatus or a setting for capturing a packet relating to the communication apparatus;
a control unit configured to enable a filter condition, which includes an address of the communication apparatus, in a case where the setting unit has performed the setting for capturing a packet addressed to the communication apparatus, and to enable a filter condition, which includes a broadcast address and/or a multicast address in addition to the address of the communication apparatus, in a case where the setting unit has performed the setting for capturing a packet relating to the communication apparatus;
a determination unit configured to determine whether a packet received via the network satisfies the filter condition; and
a capture unit configured to capture the received packet in a case where the determination unit has determined that the filter condition is satisfied.

2. The apparatus according to claim 1, wherein the filter condition contains priority information, and the determination unit determines whether the filter condition is satisfied by referring to the address of the received data and the address included in the filter condition in the order of the priority.

3. The apparatus according to claim 1, further comprising a storage unit configured to store correspondence between protocols and multicast addresses;
wherein the control unit enables a filter condition that includes a multicast address that has been stored in the storage unit.

4. The apparatus according to claim 1, further comprising:
a discrimination unit configured to discriminate whether the received data is in conformity with a specific protocol;
an identification unit configured to identify whether the data is data indicating joining of a multicast group or data indicating leaving of a multicast group in a case where the discrimination unit has discriminated conformity with the specific protocol; and
a unit configured to add a corresponding multicast address to the filter conditions if the identification unit identifies that the data is data indicating joining, and to delete a corresponding multicast address from the filter conditions if the identification unit identifies that the data is data indicating leaving.

5. A control method of controlling a communication apparatus capable of communicating with a device on a network for capturing packets transmitted from the device, the method comprising:
a setting step of performing a setting for capturing a packet addressed to the communication apparatus or a setting for capturing a packet relating to the communication apparatus;
a control step of enabling a filter condition, which includes an address of the communication apparatus, in a case the setting for capturing a packet addressed to the communication apparatus has been performed in the setting step, and enabling a filter condition, which includes a broadcast address and/or a multicast address in addition to the address of the communication apparatus, in a case where the setting for capturing a packet relating to the communication apparatus has been performed in the setting step;
a determination step of determining whether a packet received via the network satisfies the filter condition; and
a capture step of capturing the received packet in a case where it has been determined in the determination step that the filter condition is satisfied.

6. A non-transitory computer-readable storage medium storing a program for causing a computer to execute the control method set forth in claim 5.
